(19) United States
(12) Patent Application Publication
(10) Pub. No.: US 2005/0095419 A1
(43) Pub. Date: May 5, 2005

(54) Reinforced adhered insulation material, and methods of use and making thereof

(76) Inventors: Stephen W. Raeburn, Ballston Spa, NY (US); Yismekyahuah B. Raeburn, Ballston Spa, NY (US); Rachal Raeburn, Ballston Spa, NY (US)

Correspondence Address: Schmeiser, Olsen & Watts LLP;Suite 201, 3 Lear Jet Lane, Latham, NY, 12110, US

(21) Appl. No.: 10/883,234

(22) Filed: Jul. 1, 2004

(51) Int. Cl. B32B 3/26

(52) U.S. Cl. 428/319.1; 428/314.8; 428/314.4; 428/316.6

(57) ABSTRACT

A multi-use product that includes several layers, in which the outer layers include a reinforced polymer and an interior insulation layer, wherein all the layers are adhered. A method of making and using is also disclosed.

### FIELD OF INVENTION

This invention relates generally to the field of products, or materials, used for packaging, shipping, protecting, insulating, building construction and the like. More particularly, this invention provides for a multi-use product of multiple-layers that has improved thermal qualities, tear, shear and puncture resistance and overall improved durability. The invention includes methods of use and making thereof.

### BACKGROUND OF INVENTION

Bubble insulation as it is commonly known has many uses and attributes. It can be used for its insulation qualities and for its protective traits.

However, amongst others, a significant disadvantage of bubble is its lack of strength. Its tensile strength and its puncture resistance are inadequate making bubble insulation either wholly unsuitable for some uses and plainly inferior for other uses. Further, once the bubble insulation is punctured, or torn, it has a propensity to further break apart or fracture. The same is true of other closed-cell insulation products.

Further, previous attempts to include additional layers of materials with the insulation have been unsuccessful, due, in part, to the inferior ways that the layers have been attached to each other. This results in poor durability whether or not the product has been torn, ripped, punctured, cut, and the like.

Accordingly, there is a need for a method and device that makes improvements to bubble, and other closed-cell and open-cell insulations, that overcome at least some of the aforementioned deficiencies.

### SUMMARY OF INVENTION

The present invention provides a device and method that entails an insulation that is reinforced and adhered into a laminate.

A first general aspect of the invention provides an apparatus comprising:

a first outer layer;

a second outer layer;

a third layer, located between said first and second layers, including a reflective coating; and

a fourth layer, located between said first and second layers, including an insulation, wherein said fourth layer is fully adhered to at least one of said first layer, said second layer, and said third layer.

A second general aspect of the invention provides a multi-layer device comprising:

a top outer layer and bottom outer layer;

a third layer, interposed between said outer layers, of an insulating material;

a fourth layer, comprised of a reflective conducting material; and

wherein said outer layers are heat laminated to at least one of said third layer and said fourth layer so as to produce a full adherence between said outer layers and at least one of said third layer and said fourth layer.

A third general aspect of the invention provides a multi-layered device comprising:

at least one woven polyethylene layer;

a reflective conductive layer; and

at least one layer of insulation; further wherein said at least one woven polyethylene layer, said reflective conductive layer, and said at least one insulation layer are fully adhered.

A fourth general aspect of the invention provides a method of making a reinforced adhered insulation material comprising:

providing a first layer comprised of a reinforced polymer;

providing a second layer comprised of a reinforced polymer;

situating between said first layer and said second layer a third layer, said third layer includes a closed cell insulation; and

adhering said third layer to at least one of said first layer and said second layer.

A fifth general aspect of the present invention provides a method of installing a material comprising:

providing a material, said material includes at least three layers of material, each of said layers having outer faces, wherein said outer faces are of-a polymeric material, further wherein said outer faces are fully adhered to an adjacent outer face, thereby creating a monolithic structure that includes a first portion and a second portion;

one of cutting, puncturing, opening said first portion wherein said second portion remains fully monolithic; and

installing said structure.

The foregoing and other features of the invention will be apparent from the following more particular description of various embodiments of the invention.

### BRIEF DESCRIPTION OF DRAWINGS

Some of the embodiments of this invention will be described in detail, with reference to the following figures, wherein like designations denote like members, wherein:

FIG. 1 depicts an elevation sectional view of an embodiment of the reinforced adhered insulation material, in accordance with the present invention;

FIG. 2A depicts a top, or bottom, view of an outer layer of an embodiment of the reinforced adhered insulation material, in accordance with the present invention;

FIG. 2B depicts a top, or bottom, view of an outer layer of a second embodiment of the reinforced adhered insulation material, in accordance with the present invention;

FIG. 3A depicts an elevation sectional view of a second embodiment of the reinforced adhered insulation material, in accordance with the present invention;

FIG. 3B depicts an elevation sectional view of a third embodiment of the reinforced adhered insulation material, in accordance with the present invention;

FIG. 3C depicts an elevation sectional view of a fourth embodiment of the reinforced adhered insulation material, in accordance with the present invention;

FIG. 4 depicts a perspective view of a roll of the reinforced adhered insulation material, in accordance with the present invention;

FIG. 5 depicts an elevation sectional view of an embodiment of the reinforced adhered insulation material receiving staple edges, in accordance with the present invention;

FIG. 6 depicts a perspective view of another embodiment of a roll of the reinforced adhered insulation material, in accordance with the present invention;

FIG. 7 depicts a front perspective view of an embodiment of a roll of the reinforced adhered insulation material being installed over a formed reinforced concrete wall, partially filled with concrete, in accordance with the present invention;

FIG. 8 depicts an elevation sectional view of the embodiment in FIG. 7 installed over the formed reinforced concrete wall, in accordance with the present invention;

FIG. 9 depicts an elevation sectional view of an embodiment of the material over a formed reinforced concrete wall, fully filled with concrete, in accordance with the present invention;

FIG. 10 depicts a perspective view of an embodiment of the material being installed as an underslab barrier, in accordance with the present invention;

FIG. 11 depicts an elevation sectional view of an embodiment of the material as installed as an underslab barrier and a foundation wall insulation layer, in accordance with the present invention;

FIG. 12A depicts an elevation sectional view of a fourth embodiment of the reinforced adhered insulation material, in accordance with the present invention;

FIG. 12B depicts an elevation sectional view of a fifth embodiment of the reinforced adhered insulation material, in accordance with the present invention;

FIG. 13 depicts an elevation sectional view of a wood column surrounded by an embodiment of the reinforced adhered insulation material, in accordance with the present invention; and

FIG. 14 depicts a close up view of the embodiment in FIG. 13, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. Although the drawings are intended to illustrate the present invention, the drawings are not necessarily drawn to scale.

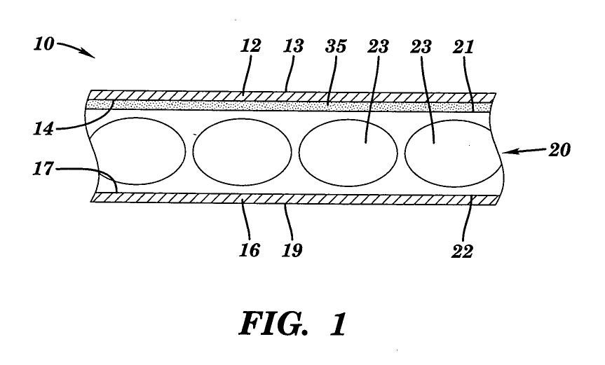

Turning to the figures, FIG. 1 depicts a cross-sectional view of one embodiment of the invention. The invention, a reinforced adhered insulation material, hereinafter called 10 includes multiple layers of material. The material, or apparatus, 10 includes two outer layers 12, 16. Located between the outer layers 12, 16 are two inner layers, namely an insulation layer 20 and a reflective conductive layer 35.

The outer layers 12, 16 are a scrim layer 12, 16. The scrim outer layers 12, 16 are a reinforced layer that is resistant to initial tearing, abrading, and/or puncturing, as well as, resistant to any expansion of the tear, abrasion, and/or puncture should the layer 12,16 become torn, abraded, and/or punctured. The scrim layer 12, 16 may include fibrous material in batt, scrim, fabric, or woven form. The scrim layer 12, 16 may be woven polymers.

In the embodiment shown, the outer layers 12, 16 are made of polyethylene. The insulation layer 20, in this embodiment, is made of a bubble insulation. The reflective conductive layer 35 is comprised, in this embodiment, of a metallic layer with a coating of a polymeric material or a polymeric layer that includes coatings that have reflective and conductive properties (e.g., silver-colored paint, etc.).

Alternatively, the outer layers may be a polymeric material including but not limited to: acrylonitrile-butadiene (ABA), acrylonitrile-butadiene styrene polymer (ABS), acrylonitrile-chlorinated polyethylene styrene terpolymer (ACS), acrylate maleic anhydride terpolymer (AMA), acrylonitrile-methyl methacrylate (AMMA), amorphous polyolefin (APO), acrylonitrile styrene copolymer (AS), acrylonitrile styrene acrylate (ASA), cellulose acetate (CA), cellulose acetate butyrate (CAB), cellulose acetate proprionate (CAP), cellulose nitrate (CN), cycloolefin copolymer (COC), copolyester thermoplastic elastomer (COP), chlorinated polyethylene (CPE), chlorinated polyvinyl chloride (CPVC), cellulose triacetate (CTA), chlorotrifluoroethylene (CTFE), ethylene acrylic acid copolymer (EAA), ethyl cellulose (EC), ethylene chlorotrifluoroethylene (ECTFE), ethylene n-butyl acetate (EnBA), ethylene propylene diene monomer rubber (EPDM), ethylene propylene copolymer rubber (EPM), ethylene propylene rubber (EPR), expandable polystyrene (EPS), ethylene tetrafluoroethylene (ETFE), ethylene vinyl acetate (EVA), ethylene/vinyl acetate copolymer (E/VAC), fluorinated ethylene propylene (FEP), fiber reinforced plastic (FRP), high impact polystrene (HIPS), high molecular weight high density polyethylene (HMWHDPE), interpenetrating polymer network (IPN), linear low density polyethylene (LLDPE), linear polyethylene (LPE), maleic anhydride (MA), methyl methacrylate/ABS copolymer (MABS), methyl methacrylate butadiene styrene terpolymer (MBS), medium density polyethylene (MDPE), melamine phenolic (MP), olefin modified styrene acrylonitrile (OSA), polyamide (PA), polyamide-imide (PAI), polyaryletherketone (PAEK), polyester aklyd (PAK), polyaniline (PAL), polyacrylonitrile (PAN), polyaryl amide (PARA), polyarylsulfone (PAS), polybutylene (PB), polybutadiene acrylonitrile (PBAN), polybutadine (PBD), polybenzimidazole (PBI), polybutylene naphthalate (PBN), polybutadiene styrene (PBS), polybutylene terephthalate (PBT), polycaprolactone (PCL), polycylohexylene terephthalate (PCT), polymonochlorotrifluoroethylene (PCTFE), polyetheretherketone (PEEK) polyetherimide (PEI), polyethylene naphtalene (PEN), polyethylene oxide (PEO), polyethersulfone (PES), polyethylene terephthalate (PET), perfluoroalkoxy (PFA), polyimide (PI), polyisoprene (PI), polyisobutylene (PIB), polyisocyanurate (PIR), polymethactylonitrile (PMAN), polymethylmethacrylate (PMMA), polymethylpentene (PMP), paramethylstyrene (PMS), polyolefin (PO), polyoxymethylene (POM), polypropylene (PP), polyphthalamide (PPA), cholorinated polypropylene (PPC), polyphenlyene ether (PPE), polymeric polyisocyanate (PPI), polyphenylene oxide (PPO), polypropylene oxide (PPOX), polyphenylene sulfide (PPS), polyphenylene sulfone (PPSU), polypropylene terephthalate (PPT), polystyrene (PS), polysulfone (PSO, PSU), polytetrafluoroethylene (PTFE), polytetramethylene terephthalate (PTMT), polyurethane (PU), polyvinyl acetate (PVA), polyvinyl butryl (PVB), polyvinyl chloride (PVC), polyvinyl chloride acetate (PVCA), polyvinylidene acetate (PVDA), polyvinylidene chlroide (PVDC), polyvinylidene fluoride (PVDF), polyvinyl fluoride (PVF), polyvinyl carbazole (PVK), polyvinyl alcohol (PVOH), polyvinyl pryyrolidone (PVP), ultrahigh molecular weight polyethylene (UHMWPE), ultra low density polyethylene (ULDPE), vinyl acetate (VA), vinyl acetate ethylene (VAE), and very low density polyethylene (VLDPE). Any polymeric material capable of being hot sealed, hot melted, etc may be used as an outer layer 12 or outer layer 16 in accordance with the method of the present invention.

The first outer layer 12, alternatively called the top outer layer 12 includes an outside surface 13 and an inside surface 14. Similarly, the second outer layer 16, alternatively called the bottom outer layer 16 includes an outside surface 19 and an inside surface 17. The outer layers 12, 16 offer a waterproof layer of protection to the inner layers 20, 35 of the material 10.

Either surface 13, 14 of the top outer layer 12 or either surface 17, 19 of the bottom outer layer 16 may further receive a coating. The coating may be comprised of polymeric material such as Linear Low Density Polyethylene (LLDPE), High Density Polyethylene (HDPE), or Low Density Polyethylene (LDE).

Alternatively, the coating may be polymeric material including but not limited to: acrylonitrile-butadiene (ABA), acrylonitrile-butadiene styrene polymer (ABS), acrylonitrile-chlorinated polyethylene styrene terpolymer (ACS), acrylate maleic anhydride terpolymer (AMA), acrylonitrile-methyl methacrylate (AMMA), amorphous polyolefin (APO), acrylonitrile styrene copolymer (AS), acrylonitrile styrene acrylate (ASA), cellulose acetate (CA), cellulose acetate butyrate (CAB), cellulose acetate proprionate (CAP), cellulose nitrate (CN), cycloolefin copolymer (COC), copolyester thermoplastic elastomer (COP), chlorinated polyethylene (CPE), chlorinated polyvinyl chloride (CPVC), cellulose triacetate (CTA), chlorotrifluoroethylene (CTFE), ethylene acrylic acid copolymer (EAA), ethyl cellulose (EC), ethylene chlorotrifluoroethylene (ECTFE), ethylene n-butyl acetate (EnBA), ethylene propylene diene monomer rubber (EPDM), ethylene propylene copolymer rubber (EPM), ethylene propylene rubber (EPR), expandable polystyrene (EPS), ethylene tetrafluoroethylene (ETFE), ethylene vinyl acetate (EVA), ethylene/vinyl acetate copolymer (E/VAC), fluorinated ethylene propylene (FEP), fiber reinforced plastic (FRP), high impact polystrene (HIPS), high molecular weight high density polyethylene (HMWHDPE), interpenetrating polymer network (IPN), linear low density polyethylene (LLDPE), linear polyethylene (LPE), maleic anhydride (MA), methyl methacrylate/ABS copolymer (MABS), methyl methacrylate butadiene styrene terpolymer (MBS), medium density polyethylene (MDPE), melamine phenolic (MP), olefin modified styrene acrylonitrile (OSA), polyamide (PA), polyamide-imide (PAI), polyaryletherketone (PAEK), polyester aklyd (PAK), polyaniline (PAL), polyacrylonitrile (PAN), polyaryl amide (PARA), polyarylsulfone (PAS), polybutylene (PB), polybutadiene acrylonitrile (PBAN), polybutadine (PBD), polybenzimidazole (PBI), polybutylene naphthalate (PBN), polybutadiene styrene (PBS), polybutylene terephthalate (PBT), polycaprolactone (PCL), polycylohexylene terephthalate (PCT), polymonochlorotrifluoroethylene (PCTFE), polyetheretherketone (PEEK) polyetherimide (PEI), polyethylene naphtalene (PEN), polyethylene oxide (PEO), polyethersulfone (PES), polyethylene terephthalate (PET), perfluoroalkoxy (PFA), polyimide (PI), polyisoprene (PI), polyisobutylene (PIB), polyisocyanurate (PIR), polymethactylonitrile (PMAN), polymethylmethacrylate (PMMA), polymethylpentene (PMP), paramethylstyrene (PMS), polyolefin (PO), polyoxymethylene (POM), polypropylene (PP), polyphthalamide (PPA), cholorinated polypropylene (PPC), polyphenlyene ether (PPE), polymeric polyisocyanate (PPI), polyphenylene oxide (PPO), polypropylene oxide (PPOX), polyphenylene sulfide (PPS), polyphenylene sulfone (PPSU), polypropylene terephthalate (PPT), polystyrene (PS), polysulfone (PSO, PSU), polytetrafluoroethylene (PTFE), polytetramethylene terephthalate (PTMT), polyurethane (PU), polyvinyl acetate (PVA), polyvinyl butryl (PVB), polyvinyl chloride (PVC), polyvinyl chloride acetate (PVCA), polyvinylidene acetate (PVDA), polyvinylidene chlroide (PVDC), polyvinylidene fluoride (PVDF), polyvinyl fluoride (PVF), polyvinyl carbazole (PVK), polyvinyl alcohol (PVOH), polyvinyl pryyrolidone (PVP), ultrahigh molecular weight polyethylene (UHMWPE), ultra low density polyethylene (ULDPE), vinyl acetate (VA), vinyl acetate ethylene (VAE), and very low density polyethylene (VLDPE). Any polymeric material capable of being dispersed, dispensed, etc as a coating may be used as a coating in accordance with the method of the present invention.

The coatings can increase the strength of the material 10. Further, any color can be used for the coatings for different applications. For example, the top surface 13 of the top outer layer 12 may receive a black coating. For certain applications, the black coating will increase the heat retention of the material 10. Similarly, the bottom surface 14 of the top outer layer 12 may receive a silver, or similar reflective, coating. The silver, or reflective, coating would aid in reflective capability of the material 10. Thus, a silver coating could be placed on various surfaces 13, 14, 17, 19 of various layers 12, 16 depending on the application and the direction towards which the additional reflective qualities are desired. Likewise, a white coating could be placed on various surfaces 13, 14, 17, 19 to enhance reflective qualities of the particular layer to which it is adhered to.

The bubble layer 20 includes a top surface 21 and a bottom surface 22 with an approximate plane of a plurality of bubbles 23 therebetween. The plurality of bubbles 23 may be sized in any standard bubble sizes (e.g., ¼″, ½″, ¾″, etc.) or any custom bubble sizes.

Alternatively, the insulation layer 20 may be closed-cell foam insulation made from materials such as closed-cell polyethylene foam, polypropylene foam, and the like.

The inner layers 20, 35 are adhered in some fashion to at least one of the outer layers 12, 16. In the embodiment shown both inner layers 20, 35 are adhered to each other and to the respective adjacent outer layer 12, 16. For example, the metallic layer 35 is adhered to both the inner surface 14 of the top outer layer 12 and to the top surface 21 of the bubble layer 20. Similarly, the bottom surface 22 of the bubble 20 is adhered to the inner surface 17 of the bottom outer layer 16.

The term, adhered, as used herein means that the two, or more, layers of material are attached to each other via a heating and melting process wherein the two layers of material have different melting temperatures and upon the heating of one, or both, of the adjacent layers results in a adhesion between the two material layers in the area wherein the heat was applied, and subsequent melting has taken place.

The term, adhered, further means that the two, or more layers, are adhered in the region wherein the heating of the one, or both, layers took place. Thus, while the entire area of a layer may be heated, it is not necessary for the entire area of the layer to be heated. For example, instead of heating the entire layer area, a smaller portion, or section, of the layer may be heated. This would result in the smaller portion, or section, being adhered. Further, the heating to the requisite melting temperature may be applied in a particular pattern on a layer. One example, may be only heating a perimeter boundary of the layer. In this manner, only the perimeter boundaries of the layers will be adhered. Another example, includes heating nearly the entire area of the layer with the exception being a certain shaped pattern, wherein no heat is applied. In this manner, the at least two layers will be adhered nearly fully except for the area of the shaped (i.e., non-heated) pattern. One way in order to selectively apply heat to the layer, would be to add an insulative material along a portion of heated rollers that the material passes by, therein allowing heat to be applied to selective portions of the layers.

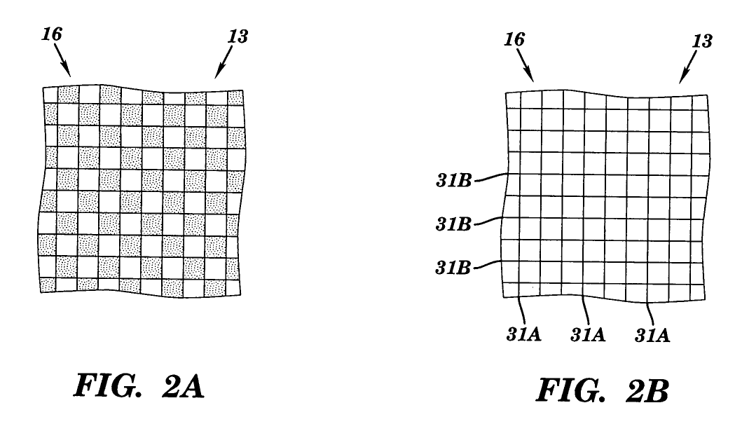

FIGS. 2A and 2B shown top, or bottom, views of two different embodiments of the outer layers 13, 16 of scrim. The outer layers 13, 16 are a reinforced polymer. The layers 13, 16 may be polyethylene (e.g, LLDPE, HDPE, LDE, etc.). The reinforcement may be obtained by having a woven polyethylene (See FIG. 2A), wherein alternating strips of polyethylene are interwoven in a repeating pattern. Alternatively, reinforcing to the outer layers 13, 16 can be provided by a cross-pattern of reinforcing elements 31A, 31B.

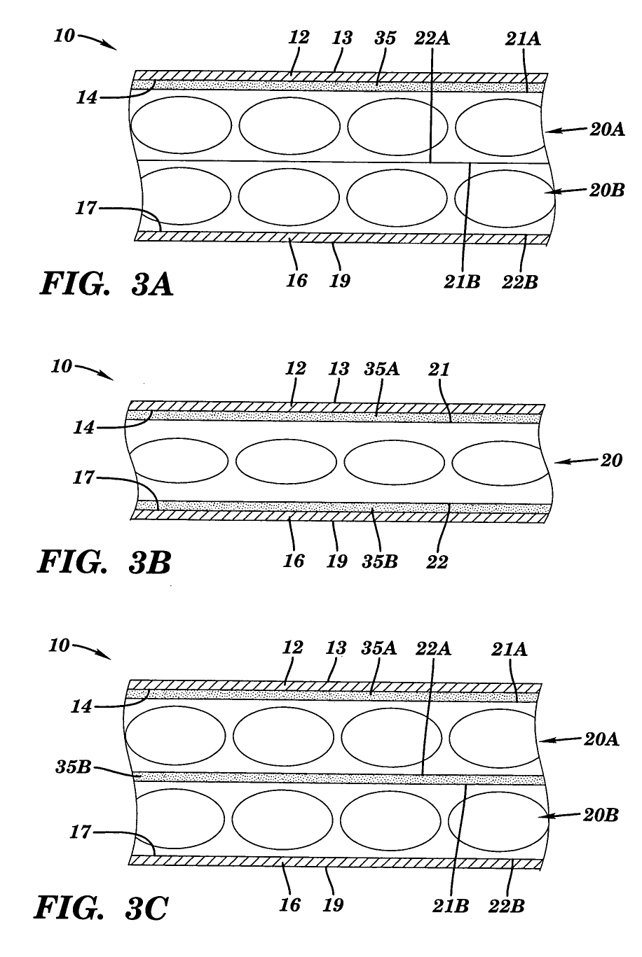

FIGS. 3A, 3B, and 3C all depict a similar view (i.e., cross-sectional elevation) as FIG. 1, of alternative embodiments. Additional layers and/or coatings may be added to the material 10 in various quantities and configurations. For example, FIG. 3A shows an embodiment wherein there are two closed-cell insulation layers 20A, 20B. A first layer of closed-cell insulation (e.g., bubble) 20A is bonded, or adhered, to a second layer of closed-cell insulation (e.g., bubble) 20B. A top surface 21B of the bottom layer 20B is adhered to the bottom surface 22A of the top layer 20A. Similarly, the bottom surface 22B of the bottom layer 20B is adhered to the interior surface of the bottom outer layer 16. Additionally, a top surface 21A of the top layer 20A is adhered to the metallic layer 35. As in the embodiment shown in FIG. 1, the metallic layer 35 is adhered to the interior surface 14 of the top outer layer 12.

The embodiment shown in FIG. 3B has multiple metallic layers 35, that is a top metallic layer 35A and a bottom metallic layer 35B. The top metallic layer 35A is adhered to both the interior surface 14 of the top outer layer 12 and to the top surface 21 of the closed-cell insulation layer 20. This configuration is repeated symmetrically on the bottom half of the material 10. That is the bottom metallic layer 35B is adhered to both the interior surface 17 of the bottom outer layer 16 and to the bottom surface 22 of the closed-cell insulation layer 20.

FIG. 3C depicts a third embodiment of the material 10 wherein there are multiple closed-cell insulation layers 20 and multiple metallic layers 35. Interspersed between the top closed-cell insulation layer 20A and the bottom closed-cell insulation layer 20B is a second metallic layer 35B. Interspersed between the top closed-cell insulation layer 20A and the top outer layer 12 is a first metallic layer 35A. Thus, the top metallic layer 35A is adhered to both the interior surface 14 of the top outer layer 12 and the top surface 21A of the top closed-cell insulation layer 20A. Similarly, the bottom metallic layer 35B is adhered to both the interior surface 17 of the bottom outer layer 16 and the bottom surface 22B of the bottom closed-cell insulation layer 20B. The bottom outer layer 16 is adhered at its interior surface 17 to the bottom surface 22B of the bottom closed-cell insulation layer 20B.

Further, additional layers of material may be placed between the outer layers 12, 16. In any of these additional interior layers they are either of a polymeric material and/or coated with one of the aforementioned polymeric materials. For example the additional interior layers may be made of polyester, cotton, paper, sunbrella®, etc. or a combination thereof. The coating of the applicable interior layer with a polymeric coating and subsequent heating to a requisite temperature provides the capability of a fully adhered layered product.

It should be apparent to one skilled in the art, that numerous configurations are attainable wherein at least one closed-cell insulation layer 20 is adhered with a top outer layer 12 and a bottom outer layer 16 thereby providing a reinforced adhered insulation material 10.

The material 10 can be configured in, virtually, any size, shape, and configuration. For example, the material 10 can be made in sizes like a blanket, or tarpaulin. Material 10 made in these sizes would be convenient for applications such as concrete curing covers, shipping blankets, under-concrete slab waterproof membranes, waterproof layers, and the like. The embodiments could be generally fixed in shape and size.

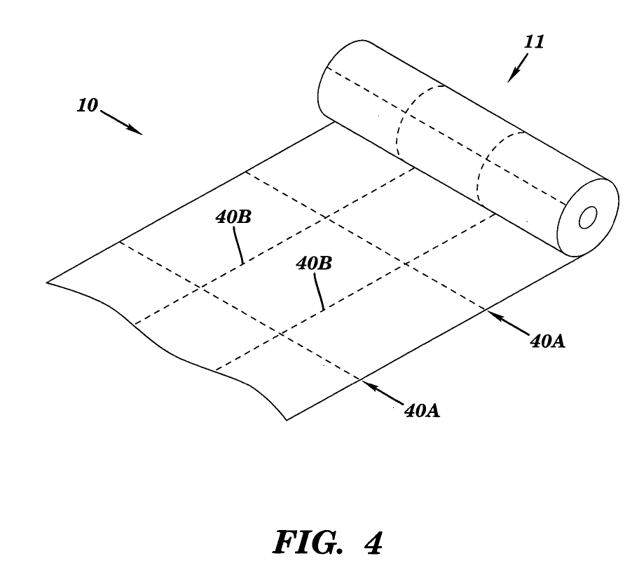

Alternatively, the size and shape of the material 10 may be user-selectable. That is various means can be incorporate into the material 10 so as to allow the user to parcel out the desired shape and/or size for the particular application. FIG. 4 depicts a perspective view of a roll 11 of the material 10. In this embodiment, the roll 11 may include perforations 40 so as to assist the user in tearing at the perforations 40 the desired shape and size. For example, transverse to the roll 11 may be a first set of perforations 40A that are parallel to each other that allow for the full removal of a section of material 10 in the desired length. Additionally, there may be a second set of perforations 40B that are longitudinal to the roll 11. The second set of perforations 40B allow for the selection of varying width(s) of material 10 to be removed from the roll 11 for the desired use. In this manner, a user-selectable and virtually customizable shape and size of material 10 can be obtained. Perforations 40 are defined as an opening, slit, hole, to at least one layer or coating of the material 10, but not through the full depth of the material 10. That is a perforation 40 is partially through the material 10.

The further advantage of the adherence properties of the material 10 allow for the user to further cut, punch, tear, etc. the material 10 into any shape and size without the disadvantage of any of the layers becoming unadhered. That is the material 10 acts, in essence, as a single monolithic structure.

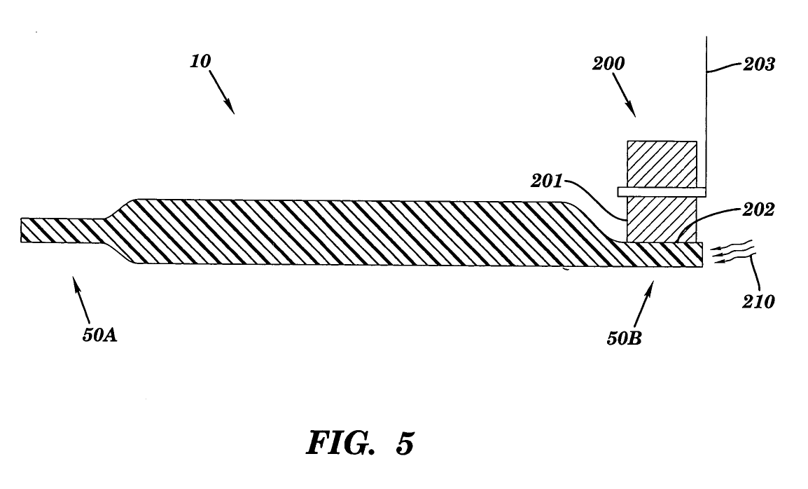

An additional feature can be provided with the material 10 wherein, as shown in FIG. 5, a combination of hot gas 210 (e.g., air, oxygen, etc.) and pressure is applied to portions of the material 10. In the embodiment shown, a compression means 200 is used to selectively apply pressure where hot air 210 is applied. As a result, a compression region 50 can be formed. As FIG. 5 shows a first compression region 50A has already been formed, while a second compression region 50B is currently being formed. The compression means 200 includes a roller 201 with bearing surface 202 held on a support 203. The support 203 is movable (both vertically and horizontally), thus, allowing the roller 201 to engage (i.e., compress) with the material 10 and/or to disengage with the material 10 in various patterns and/or locations. By compressing selective portions of the material 10, additional functions can be obtained.

It should be apparent that, while the compression regions 50 are shown along the periphery of the material 10, other locations and configurations of compression regions 50 are obtainable. For example, compression regions 50 could be interspersed either longitudinally, or transversely, along the material 10. Compression regions 50 may be symmetrical or asymmetrical about either axis. Various patterns (e.g., checkerboard, lines, crossing, diagonal, etc.) of compression regions 50 can, likewise, be made.

Similarly, different width compression regions 50 can be made. Thus, while the bearing surface 202 in FIG. 5 is of a certain width. Either wider, or more narrow, bearing surfaces 202 may be employed. For example, a much narrower (e.g., 1/4″, etc.) bearing surface 202 could be used to make compression regions 50. In this embodiment, the compression regions 50 would act more like a folding line, or kerf. The folding line would allow the material 10 to be either pre-folded, in the manufacturing process, out of a single plane or merely aid the user in folding the material 10 out of plane, in situ, more readily.

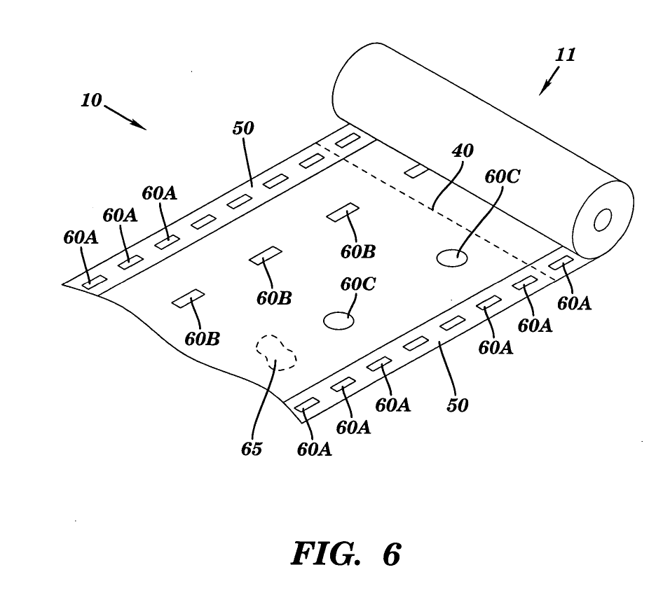

FIG. 6 depicts a perspective view of another embodiment of a roll 11 of material 10. Included on the roll 11 are perforations 40 transverse to the roll 11 and periphery compression regions 50. Further included on the material 10 are various holes 60. For example, there are a plurality of holes 60A along the periphery compression regions 50. Further, there are a plurality of holes 60B, 60C located on the “field” (i.e., non-compression regions 50) of the material 10. One group of holes 60B are rectangular, while a second group of holes 60C are round.

Further depicted in phantom is a post-manufactured opening 65 of arbitrary shape. This opening 65 may be made by the user with manual or automated means (e.g., knife, scissors, blade, etc.). Alternatively, the opening can be made by a machine (not shown).

It should be apparent that virtually any shape, size and pattern of perforation 40, holes 60, or post-manufactured opening 65 may be may be provided on either a compression region 50 or a non-compression region of the material 10. Ultimately, the perforation 40, hole 60, or post-manufactured opening 65 may result in an opening 70. As with the a tear, abrasion, and/or puncture in the material 10, the construct of the material 10 is such that the opening 70 will not provide a region for delamination of the layers of material 10 due to their adherence.

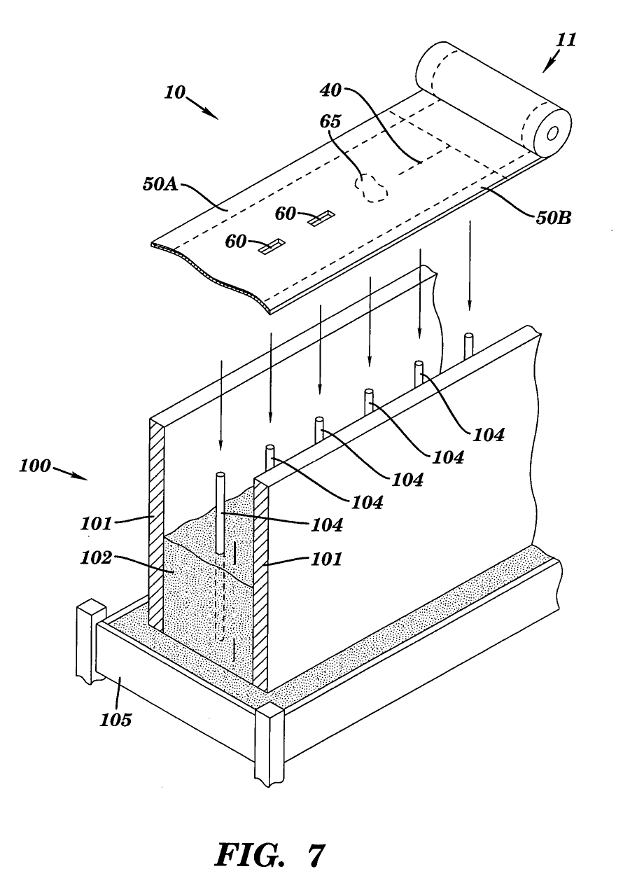

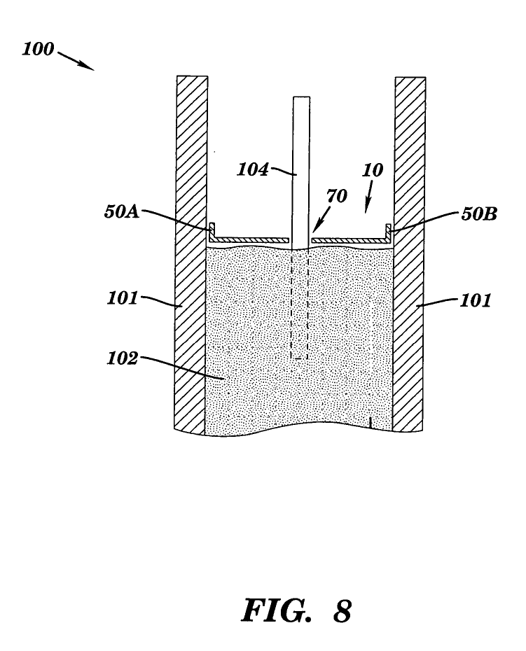

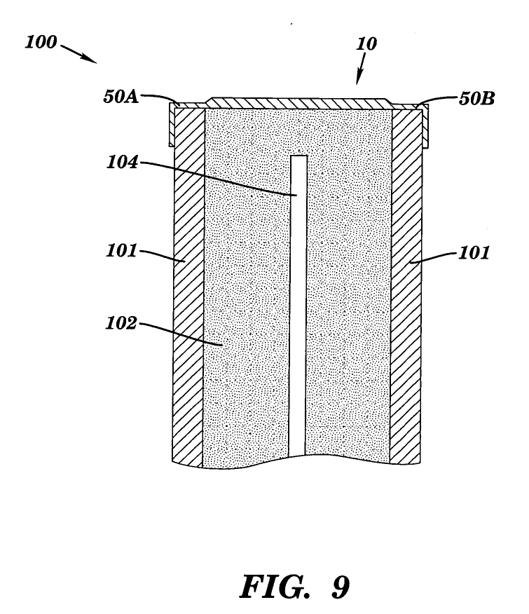

FIGS. 7 and 8 show a perspective and sectional elevation, respectively of an embodiment appropriate in the curing of concrete. As depicted, formwork 100 is installed in the preparation of the placing of concrete during construction. A common situation is where a partially completed vertical element (e.g., foundation wall, concrete wall, etc.) is being built out of reinforced concrete. The formwork 100 includes two opposing forms 101 extending vertically above a base footing 105, with reinforcing steel (i.e., “rebar”) 104 interspersed therebetween. Often newly placed concrete 102 is placed between the forms 101 wherein the concrete 102 does not extend the full finished height of the element. For example, the concrete 102, in its first placement within the formwork 100 may reached approximately half the height of the forms 101. Alternatively, the concrete 102 may indeed reach near to the full height of the forms 101 (See e.g., FIG. 9). In either event, protection of this new concrete 102 from external effects and maintenance of moisture within the concrete during curing, is necessary.

An advantage of the invention, as shown in this embodiment (See FIGS. 7 and 8) is that the material 10 is configurable by the user so as to, effectively, custom-fit the particular sizing and spacing of formwork 100 and the spacing of the reinforcing 104 without the loss of the full integrity and lamination of the material 10. As shown in FIG. 7, holes 60, perforations 40, and/or post-manufactured 65 may be used to create openings 70 for the rebar 104 to pass through (see FIG. 8).

In FIG. 8, a portion of material 10 can be shown, effectively suspended above freshly placed concrete 102 between the formwork 100. The material 10 includes longitudinally spaced openings 70 that are spaced and configured to allow for periodically spaced reinforcing 104 to extend through the material 10. Further, extending longitudinally, in parallel along the roll 11 of material 10 are two opposing compression sections 50A, 50B. The compression sections 50A, 50B are sized and spaced apart, in this embodiment, so that they may extend vertically so that they may offer adequate nailing, or adhesion, surfaces. In this manner, the material 10 may be located desirously against, or adjacent, to the concrete 102. Further, the possibility of wind, inclement weather (e.g., precipitation, snow, etc.), construction debris, and the like, reaching the curing concrete 102 is minimized. Additionally, the curing of the concrete 102 is improved because the material 10 also serves as a vapor barrier, thereby preventing undesirous rapid curing of the concrete. Further, even though the reinforcing 104 penetrates the material 10, the full lamination of the layers in the material 10 are such that separation between the layers is similarly negated.

It should be apparent that although the opening 70 through the material 10 is shown along the material 10 in an axial fashion, openings 70 may be made in any location, or any pattern on the material 10. Further, the openings 70 can be made either in a compressed area 50 or a non-compressed area (i.e., “field”) of the material 10.

FIG. 9 similarly offers an elevation view of formwork 100 and the placement of concrete 102. In this embodiment, the concrete 102 has been placed the full height of the formwork 100, thereby fulling embedding the rebar 104 in the concrete 102. As a result, material 10 with compressions areas 50A, 50B, is placed over the top of the form walls 101. The material 10 may be attached to the formwork 100.

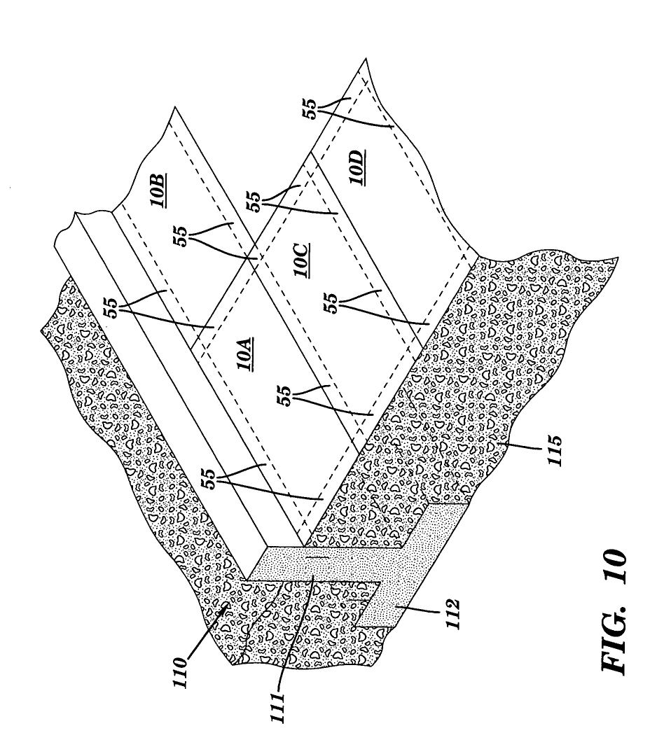

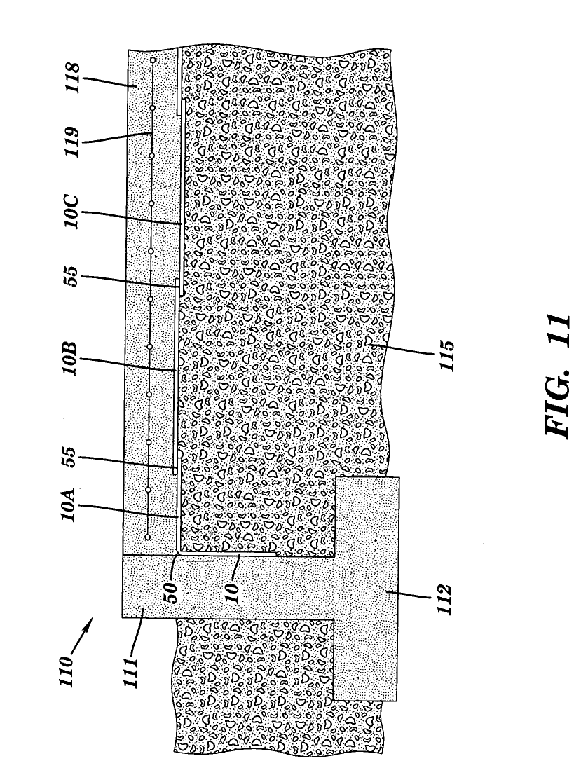

FIG. 10 depicts another embodiment and application for the material 10. A partially completed construction is shown, wherein a foundation 110 includes a footer 112 and wall 111 bearing thereon. In a typical construction of a slab-on-grade construction reinforced concrete is placed to form a slab 118 (see FIG. 11). Below the slab 118, is compacted gravel and/or subgrade 115. Located between the subgrade 115 and the slab 118 are a plurality of sheets of material 10. The sheets of material (e.g., 10A, 10B, 10C, 10D, etc.) offer both a vapor barrier and an insulation layer between the subgrade 115 and concrete slab 118. Along the perimeter of the material sheets 10 may be placed an attachment means 55 (e.g., double-side tape, glue, adhesive, etc.). The attachment means 55 may also be waterproof. This aids in creating a monolithic waterproof membrane out of all the sheets of material 10A, 10B, 10C, 10D. Further, as discussed above, the sheets of material 10 also another advantage if there are any penetrations (not shown) required through the material 10, there will be no concomitant tearing, ripping, delamination, etc. Examples of the penetrations through the material 10 in this application include penetrations for electrical, plumbing, HVAC, structural items, and the like.

FIG. 11 shows an elevation cross-section of the application depicted in FIG. 10 with the reinforced concrete slab 118 installed over the material 10. The slab 118 includes welded-wire fabric 119. Further shown is a portion of a sheet of material 10A wherein it is bent so as to be both an insulation barrier vertically adjacent to the foundation wall 111 and a portion of the vapor barrier under the slab 118. A compression region 50 may be installed along the bend of the sheet 10A so as to aid in the bending.

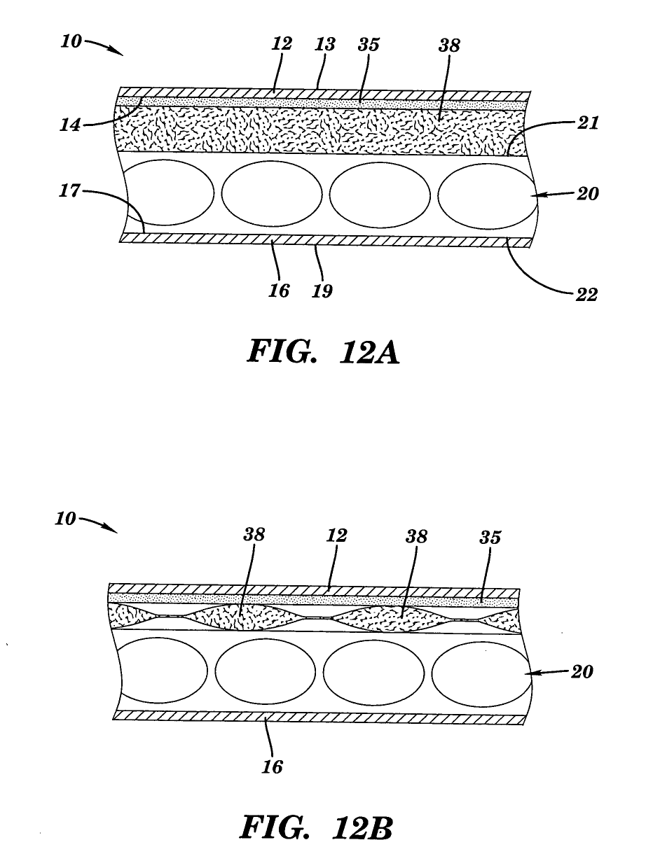

FIGS. 12A and 12B show a cross section of two additional embodiments of the present invention wherein in addition to the aforementioned layers (e.g,. 12, 35, 20, 16, etc.), a layer 38 may be added to the material 10 that includes at least one cavity for containing a material (i.e., gas, gel, liquid, powder). The layer 38, hereafter termed the GGL (gas, gel, liquid) layer can be a single cavity (see FIG. 12A) or a plurality of cavities (see FIG. 12B). The at least one cavity can be filled with an insecticide, poison, antibiotic, fungicide, or some combination thereof, so that the material 10 can provide an improved barrier to any requisite vector 180 (e.g., insects, animals, bacteria, fungus, etc.).

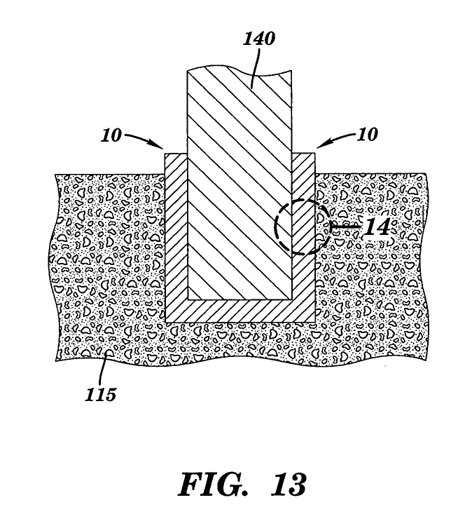

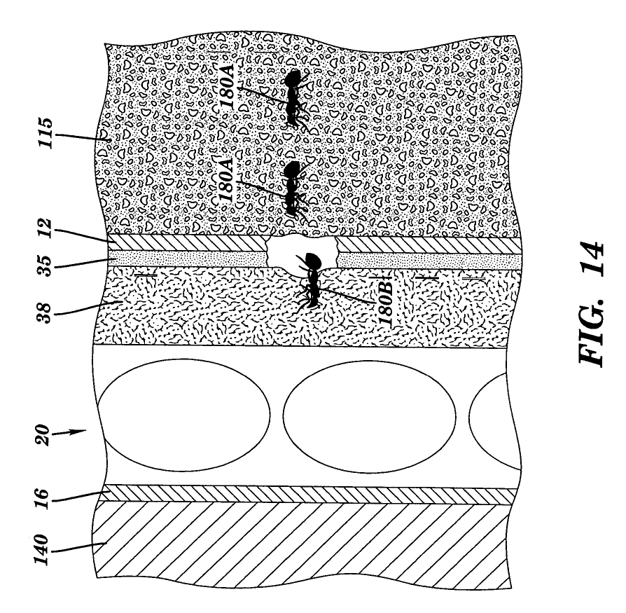

For example, as shown in FIGS. 13 and 14, an embodiment such as shown in FIGS. 12A or 12B, can be placed between a wood post 140 partially submerged into the subgrade 115. The material 10 can be constructed and/or cut and/or folded so as to fully surround the portion of the post 140 within the subgrade 115. As FIG. 14 shows a plurality of vectors 180 (e.g., ants) are attempting to reach, in this case, the wood post 140. Although a potion of the outer layers 12, 35 have been compromised by the ants 180, upon the ants 180 reaching the GGL layer 38 they become exposed to the particular gas, gel, and/or liquid in the layer 38 and become dead vectors 180B.

Although FIGS. 12A and 12B indicate that the gas, gel, liquid, powder, may be located within at least one cavity, it should be apparent that alternatively, or in addition, the requisite gas, gel, liquid, powder, can be placed within the polymer used in at least one layer or polymer coating. Similarly, the gas, gel, liquid, or powder can be located within, or upon, any of the layers of material.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

1. An apparatus comprising:
a first outer layer;
a second outer layer;
a third layer, located between said first and second layers, including a reflective coating; and
a fourth layer, located between said first and second layers, including an insulation, wherein said fourth layer is fully adhered to at least one of said first layer, said second layer, and said third layer.

2. The apparatus of claim 1, wherein said third layer includes a metal.

3. The apparatus of claim 1, wherein said insulation is a closed cell insulation.

4. The apparatus of claim 3, wherein said closed cell insulation is at least one layer of a bubble insulation.

5. The apparatus of claim 4, wherein said at least one layer of bubble insulation includes bubbles sized from the group consisting of ¼″, ½″, and ¾″.

6. The apparatus of claim 1, wherein said first outer layer includes woven polyethylene.

7. The apparatus of claim 1, wherein said second outer layer includes woven polyethylene.

8. The apparatus of claim 1, wherein said fourth layer is fully adhered to said third layer and at least one of said first layer and said second layer.

9. The apparatus of claim 1, further comprising a fifth layer, located between said first and second layers, comprised of a closed cell insulation.

10. The apparatus of claim 9, wherein said closed-cell insulation is a bubble insulation.

11. The apparatus of claim 1, further comprising a sixth layer, located between said first and second layers, comprised of a reflective coating.

12. A multi-layer device comprising:
a top outer layer and bottom outer layer;
a third layer, interposed between said outer layers, of an insulating material;
a fourth layer, comprised of a reflective conducting material; and
wherein said outer layers are heat laminated to at least one of said third layer and said fourth layer so as to produce a full adherence between said outer layers and at least one of said third layer and said fourth layer.

13. The device of claim 12, wherein said outer layers are comprised of a woven polyethylene.

14. A multi-layered device comprising:
at least one woven polyethylene layer;
a reflective conductive layer; and
at least one layer of insulation; further wherein said at least one woven polyethylene layer, said reflective conductive layer, and said at least one insulation layer are fully adhered.

15. A method of making a reinforced adhered insulation material comprising:
providing a first layer comprised of a reinforced polymer;
providing a second layer comprised of a reinforced polymer;
situating between said first layer and said second layer a third layer, said third layer includes a closed cell insulation; and
adhering said third layer to at least one of said first layer and said second layer.

16. The method of claim 15, wherein said adhering includes heating at least one of said first layer, second layer, or third layer to its respective melting point.

17. A method of installing a material comprising:
providing a material, said material includes at least three layers of material, each of said layers having outer faces, wherein said outer faces are of a polymeric material, further wherein said outer faces are fully adhered to an adjacent outer face, thereby creating a monolithic structure that includes a first portion and a second portion;
one of cutting, puncturing, opening said first portion wherein said second portion remains fully monolithic; and
installing said structure.

18. A method of installing a material comprising:
providing a material, said material includes at least three layers of material, each of said layers having outer faces, wherein said outer faces are of a polymeric material, further wherein said outer faces are fully adhered to an adjacent outer face, thereby creating a monolithic structure that includes a first portion and a second portion;
one of cutting, puncturing, opening said first portion wherein said second portion remains fully monolithic; and
installing said structure.
